(19) United States
(12) Patent Application Publication
(10) Pub. No.: US 2009/0236772 A1
(43) Pub. Date: Sep. 24, 2009

(54) PATTERN TRANSFER MOLD AND PATTERN TRANSFER METHOD

(75) Inventors: Chien-Min Chang, Taipei City (TW); Jung-Chin Wu, Taipei City (TW); Wan-Li Chuang, Taipei City (TW); Ho-Hsiang Wang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/325,265

(22) Filed: Dec. 1, 2008

(30) Foreign Application Priority Data
Mar. 20, 2008 (TW) 97109911

(51) Int. Cl. B29C 59/02

(52) U.S. Cl. 264/293; 425/405.1

(57) ABSTRACT

A pattern transfer mold is suitable for transferring at least one decorative pattern of a film to at least one workpiece. The pattern transfer mold includes a mold base and a mold core. The mold base has a mold cavity and an air vent associated with the mold cavity. The mold core is inserted in the mold cavity of the mold base and has an upper surface and a plurality of upper air grooves on the upper surface. The mold cavity and the mold core have a plurality of mold air channels located between the mold cavity and the mold core. The upper air grooves are associated with the air vent via the mold air channels.

### CROSS-REFERENCE TO RELATED APPLICATION

This application claims the priority benefit of Taiwan application serial no. 97109911, filed on Mar. 20, 2008. The entirety of the above-mentioned patent application is hereby incorporated by reference herein and made a part of this specification.

### BACKGROUND OF THE INVENTION

1. Field of the Invention

The present invention generally relates to a pattern transfer technology, in particular, to a pattern transfer mold and a pattern transfer method for decorating a surface.

2. Description of Related Art

Pattern transfer technologies have been widely used for decorating product appearances and marking the products. For the purpose of decorating the product appearances and marking the products, a variety of pattern transfer technologies such as screen printing, spray painting, and in-mold roller (IMR) have been developed and used currently, in which the thermal transfer technology is more widely used for decorating the product appearances.

In a thermal transfer technology in the conventional art, firstly, a film having a decorative pattern thereon is disposed on a workpiece and fixed on a surface of the workpiece. Then, a roller is rolled on the surface of the workpiece to heat the film, thereby transferring the decorative pattern on the film to the surface of the workpiece.

Although the thermal transfer technology has become one of the widely accepted decoration technologies, it still has some deficiencies. For example, since the thermal transfer technology uses the roller to heat the film, the working area is merely limited to the area that is covered by the roller. Moreover, since the roller must contact the film in order to heat the film, the roller may cause damages to the surface of the workpiece when it contacts the surface of the workpiece.

### SUMMARY OF THE INVENTION

Accordingly, the present invention is directed to a pattern transfer mold, suitable for closely attaching a film to a surface of a workpiece.

The present invention is also directed to a pattern transfer method, suitable for transferring a decorative pattern on a film to a workpiece.

As embodied and broadly described herein, the present invention provides a pattern transfer mold, suitable for transferring at least one decorative pattern of a film to at least one workpiece. The pattern transfer mold includes a mold base and a mold core. The mold base has a mold cavity and an air vent associated with the mold cavity. The mold core is inserted in the mold cavity of the mold base and has an upper surface and a plurality of upper air grooves on the upper surface. The mold cavity and the mold core have a plurality of mold air channels located between the mold cavity and the mold core. The upper air grooves are associated with the air vent via the mold air channels.

In an embodiment of the present invention, the mold core has a plurality of mold protrusions. The mold protrusions are protruded from the upper surface of the mold core and are provided for a plurality of workpieces to be mounted thereon respectively. One of the upper air grooves is located between two adjacent mold protrusions.

In an embodiment of the present invention, the air vent is associated with the mold cavity via a bottom surface of the mold cavity.

In an embodiment of the present invention, the mold air channels include a plurality of side air channels and a plurality of lower air channels. The side air channels are located between an inner side surface of the mold cavity adjacent to the bottom surface and an outer side surface of the mold core adjacent to the upper surface, and the lower air channels are located between the bottom surface of the mold cavity and a lower surface of the mold core opposite to the upper surface and adjacent to the outer side surface.

In an embodiment of the present invention, the mold cavity has a plurality of side air grooves. The side air grooves are located at the inner side surface of the mold cavity and constitute the side air channels together with the outer side surface of the mold core.

In an embodiment of the present invention, the mold core has a plurality of side air grooves. The side air grooves are located at the outer side surface of the mold core and constitute the side air channels together with the inner side surface of the mold cavity.

In an embodiment of the present invention, the mold cavity has a plurality of lower air grooves. The lower air grooves are located at the bottom surface of the mold cavity and constitute the lower air channels together with the lower surface of the mold core.

In an embodiment of the present invention, the mold core has a plurality of lower air grooves. The lower air grooves are located at the lower surface of the mold core and constitute the lower air channels together with the bottom surface of the mold cavity.

In an embodiment of the present invention, the mold base has a plurality of positioning columns, and the film has a plurality of positioning holes. The film may be positioned on the mold base, the mold core, and the workpiece by means of fitting the positioning columns into the positioning holes respectively.

The present invention further provides a pattern transfer method, suitable for transferring at least one decorative pattern on a film to at least one workpiece. The pattern transfer method includes the following steps: providing a mold base and a mold core; disposing a workpiece on an upper surface of the mold core; positioning a film on the mold base, the mold core, and the workpiece; extracting air from a space between the film and the workpiece through an air vent, mold air channels, and upper air grooves; and heating the decorative pattern.

In the step of providing the mold base and the mold core, the mold base has a mold cavity and an air vent associated with the mold cavity. The mold core is inserted in the mold cavity of the mold base and has an upper surface exposed out of the mold cavity and a plurality of upper air grooves on the upper surface. The mold cavity and the mold core have a plurality of mold air channels located there-between. The upper air grooves are associated with the air vent via the mold air channels.

In the step of positioning the film on the mold base, the mold core, and the workpiece, the film has a first surface, a second surface opposite to the first surface, and at least one decorative pattern on the first surface. The first surface of the film faces the workpiece. The air is extracted from the space between the film and the workpiece via the air vent, the mold air channels, and the upper air grooves to apply a negative air pressure to the first surface of the film, so as to closely attach the film to the workpiece. Then, the decorative pattern is heated, thereby transferring the decorative pattern from the film to the workpiece.

In an embodiment of the present invention, the pattern transfer method further includes applying a positive air pressure to the second surface of the film, so as to closely attach the film to the workpiece.

In an embodiment of the present invention, the step of disposing the workpiece further includes mounting the workpiece on at least one mold protrusion of the mold core protruded from the upper surface.

In an embodiment of the present invention, the step of positioning the film further includes respectively fitting a plurality of positioning columns of the mold base into a plurality of positioning holes of the film.

In the present invention, since the upper air grooves are associated with the air vent via the mold air channels, when extracting the air through the air vent and heating the film, the film can be uniformly and closely attached to the workpiece, so as to transfer the decorative pattern on the film to the workpiece, thereby avoiding the damages on the surface of the workpiece caused by heating with a roller in the prior art when contacting the surface of the workpiece by the roller.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic exploded view of a pattern transfer mold for transferring a decorative pattern of a film to a workpiece according to an embodiment of the present invention.

FIG. 1B is a cross-sectional view of the pattern transfer mold as shown in FIG. 1A for transferring the decorative pattern of the film to a workpiece.

FIG. 2 is a schematic horizontal cross-sectional view of a pattern transfer mold according to another embodiment of the present invention.

FIG. 3 is a schematic horizontal cross-sectional view of a pattern transfer mold according to another embodiment of the present invention.

FIG. 4 is a schematic vertical cross-sectional view of a pattern transfer mold according to another embodiment of the present invention.

FIG. 5 is a schematic vertical cross-sectional view of a pattern transfer mold according to another embodiment of the present invention.

FIGS. 6A to 6D show a flow chart of a pattern transfer method according to the present invention.

FIG. 7 is a partial schematic view of a pattern transfer mold and a workpiece according to another embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

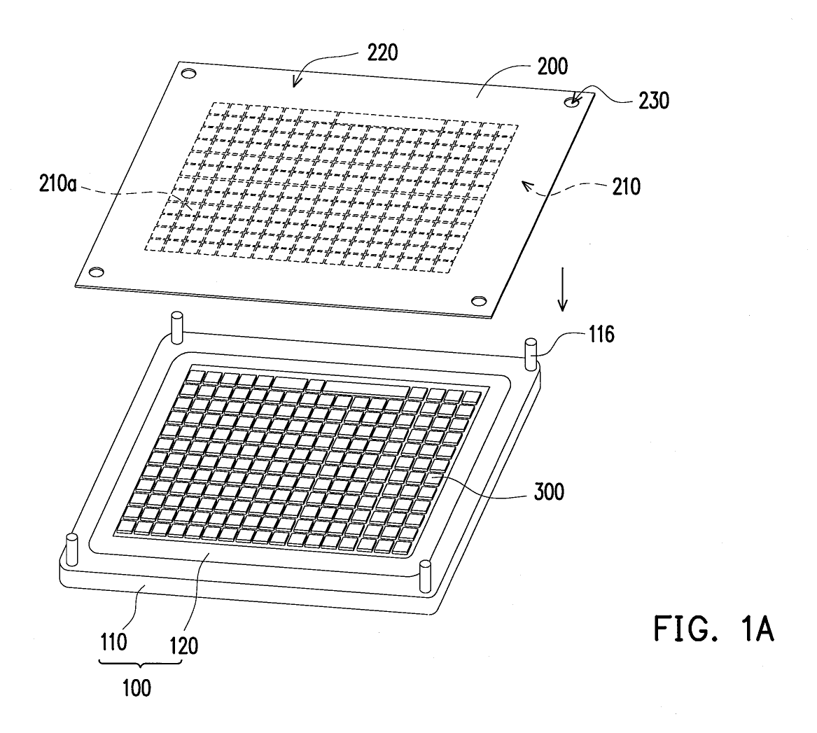

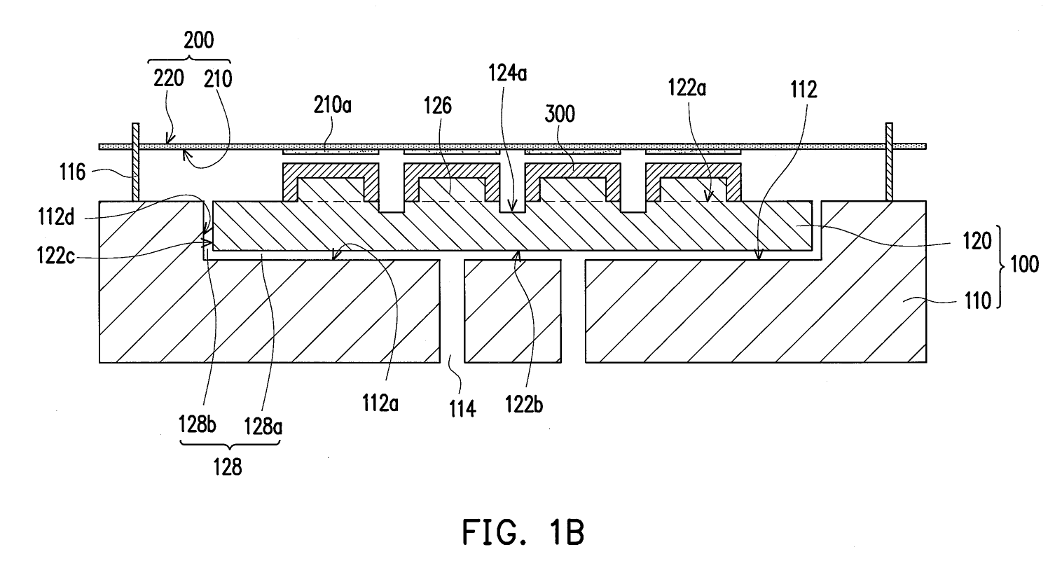

FIG. 1A is a schematic exploded view of a pattern transfer mold for transferring a decorative pattern of a film to a workpiece according to an embodiment of the present invention, and FIG. 1B is a schematic cross-sectional view of the pattern transfer mold as shown in FIG. 1A for transferring the decorative pattern of the film to the workpiece. Referring to FIGS. 1A and 1B, in this embodiment, a pattern transfer mold 100 is suitable for transferring at least one decorative pattern 210a of a film 200 to at least one workpiece 300. The decorative pattern 210a is, for example, an icon, a symbol, a letter, or a figure.

The pattern transfer mold 100 includes a mold base 110 and a mold core 120. The mold base 110 has a mold cavity 112 and an air vent 114 associated with the mold cavity 112. The mold core 120 is inserted in the mold cavity 112 of the mold base 110 and has an upper surface 122a and a plurality of upper air grooves 124a on the upper surface 122a.

The mold cavity 112 and the mold core 120 have a plurality of mold air channels 128 located between the mold cavity 112 and the mold core 120. The upper air grooves 124a are associated with the air vent 114 via the mold air channels 128. In this embodiment, the air vent 114 is associated with the mold cavity 112 via a bottom surface 112a of the mold cavity 112. Moreover, the mold core 120 has a plurality of mold protrusions 126 (only four mold protrusions are schematically shown in FIG. 1B). The mold protrusions 126 are protruded out of the upper surface 122a of the mold core 120 and are provided for a plurality of workpieces 300 (only four workpieces are schematically shown in FIG. 1B) to be mounted thereon. One of the upper air grooves 124a is located between two adjacent mold protrusions 126.

In particular, referring to FIG. 1B, the mold air channels 128 include a plurality of lower air channels 128a and a plurality of side air channels 128b. The side air channels 128b are located between an inner side surface 112d of the mold cavity 112 adjacent to the bottom surface 112a and an outer side surface 122c of the mold core 120 adjacent to the upper surface 122a. The lower air channels 128a are located between the bottom surface 112a of the mold cavity 112 and a lower surface 122b of the mold core 120 opposite to the upper surface 122a and adjacent to the outer side surface 122c.

Referring to FIG. 1A, the mold base 110 has a plurality of positioning columns 116 (only four positioning columns are schematically shown in FIG. 1A), and the film 200 has a plurality of positioning holes 230 (only four positioning holes are schematically shown in FIG. 1A). The film 200 can be positioned on the mold base 110, the mold core 120, and the workpiece 300 by means of fitting the positioning columns 116 into the positioning holes 230 respectively.

In short, since the pattern transfer mold 100 of this embodiment has a plurality of upper air grooves 124a and a plurality of mold air channels 128, when extracting the air from the space between the film 200 and the workpiece 300 through the air vent 114, the mold air channels 128, and the upper air grooves 124a, the film 200 is moved towards the workpiece 300 and thus uniformly and evenly attached to the workpiece 300 closely. Moreover, the film 200 is heated, so as to transfer the decorative pattern 210a on the film 200 to the workpiece 300, thereby avoiding the damages on the surface of the workpiece 300 caused by heating with a roller in the prior art when contacting the surface of the workpiece by the roller.

FIG. 2 is a schematic horizontal cross-sectional view of a pattern transfer mold according to another embodiment of the present invention. Referring to FIGS. 1B and 2, in this embodiment, a pattern transfer mold 100a of FIG. 2 is similar to the pattern transfer mold 100 of FIG. 1B, but differs in that, the mold cavity 112 in this embodiment has a plurality of side air grooves 112c (only two side air grooves are schematically shown in FIG. 2). The side air grooves 112c are located at the inner side surface 112d of the mold cavity 112 and constitute the side air channels 128b together with the outer side surface 122c of the mold core 120.

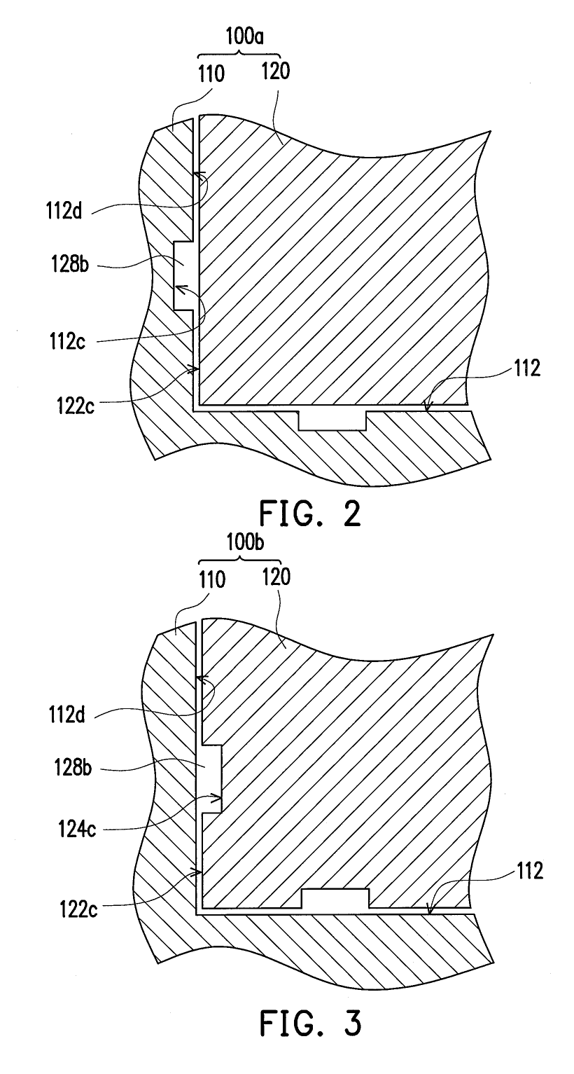

FIG. 3 is a schematic horizontal cross-sectional view of a pattern transfer mold according to another embodiment of the present invention. Referring to FIGS. 1B and 3, in this embodiment, a pattern transfer mold 100b of FIG. 3 is similar to the pattern transfer mold 100 of FIG. 1B, but differs in that, the mold core 120 in this embodiment has a plurality of side air grooves 124c (only two side air grooves are schematically shown in FIG. 3). The side air grooves 124c are located at the outer side surface 122c of the mold core 120 and constitute the side air channels 128b together with the inner side surface 112d of the mold cavity 112.

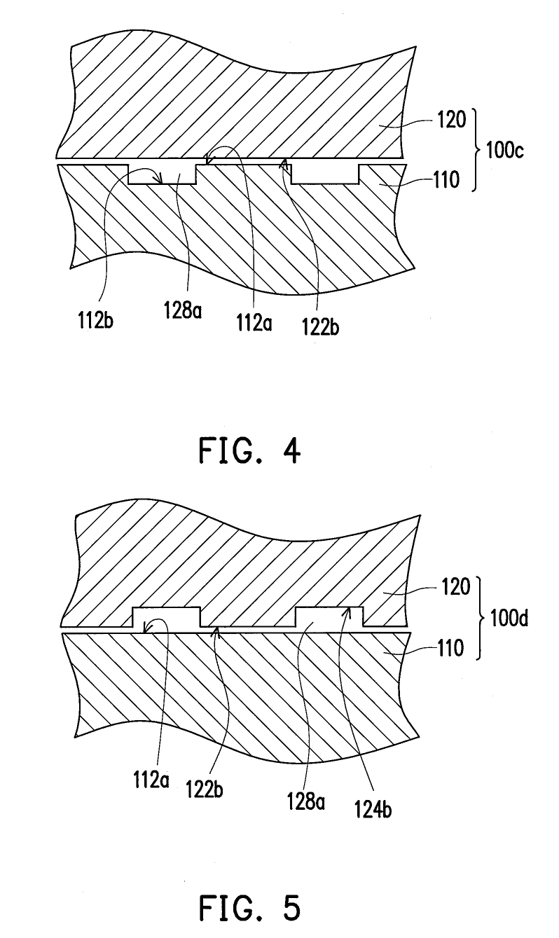

FIG. 4 is a schematic vertical cross-sectional view of a pattern transfer mold according to another embodiment of the present invention. Referring to FIGS. 1B and 4, in this embodiment, a pattern transfer mold 100c of FIG. 4 is similar to the pattern transfer mold 100 of FIG. 1B, but differs in that, the mold cavity 112 (referring to FIG. 1B) in this embodiment has a plurality of lower air grooves 112b (only two lower air grooves are schematically shown in FIG. 4). The lower air grooves 112b are located at the bottom surface 112a of the mold cavity 112 and constitute the lower air channels 128a together with the lower surface 122b of the mold core 120.

FIG. 5 is a schematic vertical cross-sectional view of a pattern transfer mold according to another embodiment of the present invention. Referring to FIGS. 1B and 5, in this embodiment, a pattern transfer mold 100d of FIG. 5 is similar to the pattern transfer mold 100 of FIG. 1B, but differs in that, the mold core 120 in this embodiment has a plurality of lower air grooves 124b (only two lower air grooves are schematically shown in FIG. 5). The lower air grooves 124b are located at the lower surface 122b of the mold core 120 and constitute the lower air channels 128a together with the bottom surface 112a of the mold cavity 112 (referring to FIG. 1B).

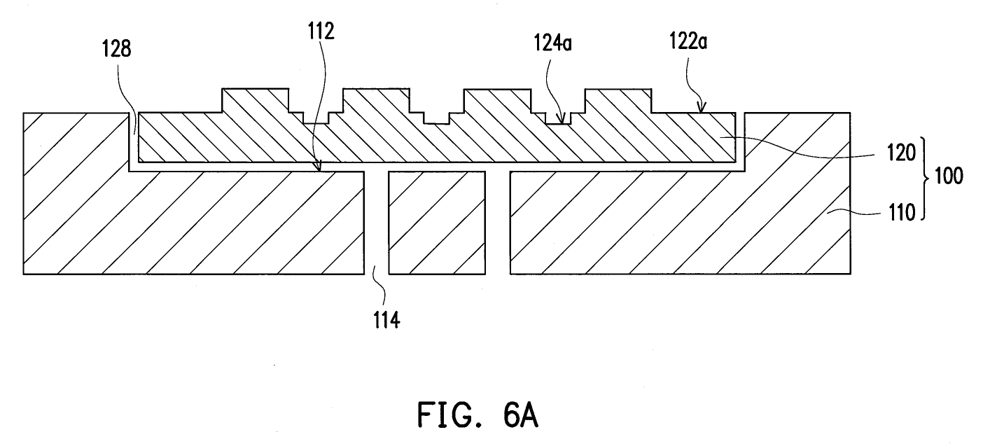

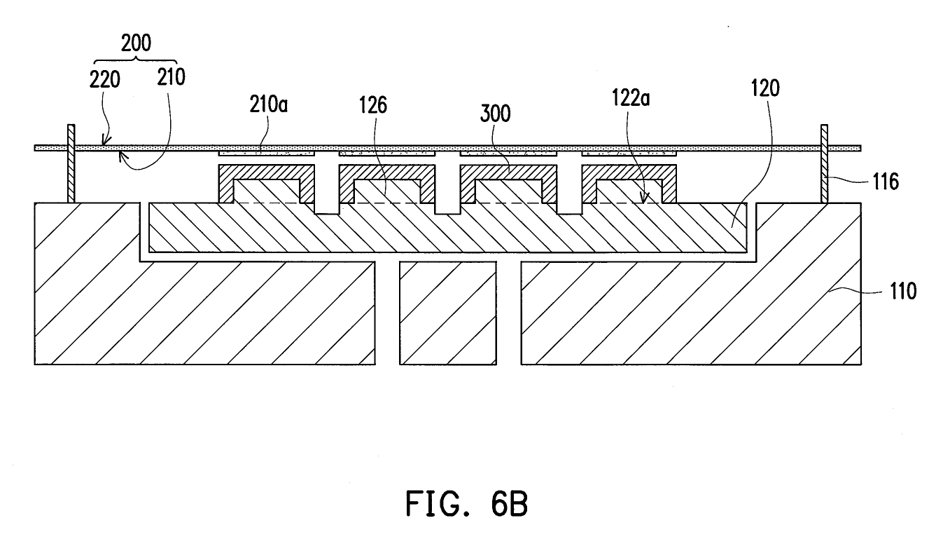

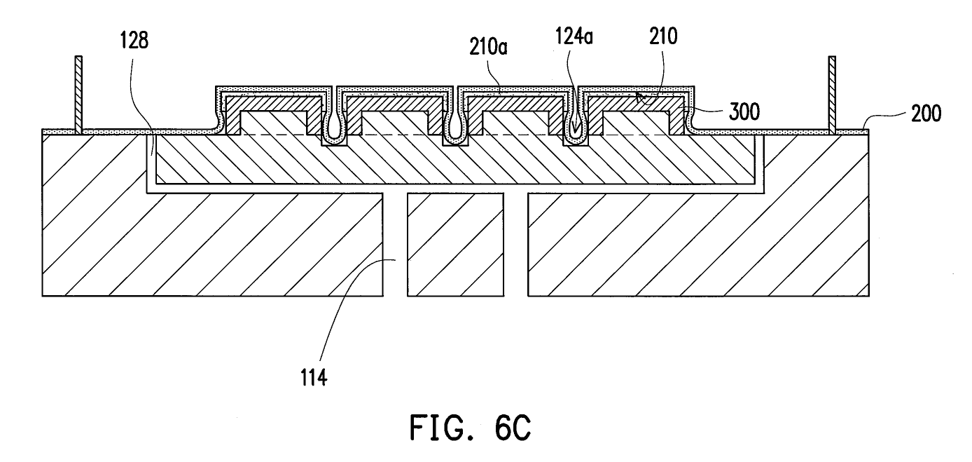

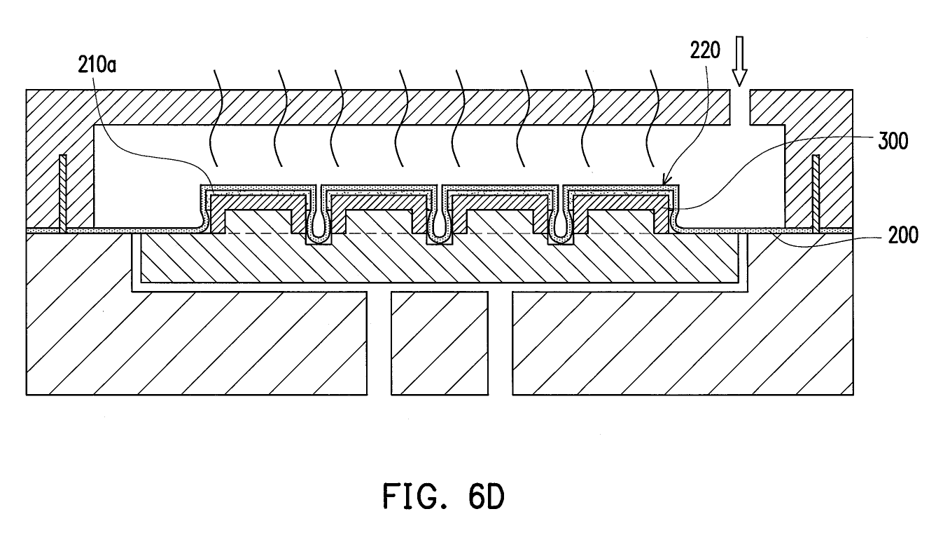

FIGS. 6A to 6D show a flow chart of a pattern transfer method according to the present invention. Referring to FIG. 6A, in the pattern transfer method, a mold base 110 and a mold core 120 are provided first. The mold base 110 and the mold core 120 constitute a pattern transfer mold 100. The mold base 110 has a mold cavity 112 and an air vent 114 associated with the mold cavity 112. The mold core 120 is inserted in the mold cavity 112 of the mold base 110 and has an upper surface 122a exposed out of the mold cavity 112 and a plurality of upper air grooves 124a on the upper surface 122a. The mold cavity 112 and the mold core 120 have a plurality of mold air channels 128 located there-between. The upper air grooves 124a are associated with the air vent 114 via the mold air channels 128.

Referring to FIG. 6B, a workpiece 300 is then disposed on the upper surface 122a of the mold core 120, and a film 200 is positioned on the mold base 110, the mold core 120, and the workpiece 300. The film 200 has a first surface 210, a second surface 220 opposite to the first surface 210, and at least one decorative pattern 210a on the first surface 210. The first surface 210 of the film 200 faces the workpiece 300.

In particular, the step of disposing the workpiece 300 further includes mounting the workpiece 300 on at least one mold protrusion 126 of the mold core 120 protruded from the upper surface 122a. The step of positioning the film 200 further includes respectively fitting a plurality of positioning columns 116 of the mold base 110 into a plurality of positioning holes 230 of the film 200 (referring to FIG. 1A), so as to position the film 200 on the mold base 110, the mold core 120, and the workpiece 300.

Referring to FIG. 6C, the air is extracted from a space between the film 200 and the workpiece 300 through the air vent 114, the mold air channels 128, and the upper air grooves 124a to apply a negative air pressure to the first surface 210 of the film 200, such that the film 200 is moved towards the workpiece 300 and is thus evenly and closely attached to the workpiece 300.

Referring to FIG. 6D, finally, the decorative pattern 210a is heated. The second surface 220 of the film 200 is heated by a heat generator (not shown) to make the film 200 become flexible after being heated, so as to transfer the decorative pattern 210a to the workpiece 300. In this embodiment, the pattern transfer method further includes applying a positive air pressure to the second surface 220 of the film 200 to closely attach the film 200 to the workpiece 300, so as to uniformly transfer the decorative pattern 210a to the workpiece 300.

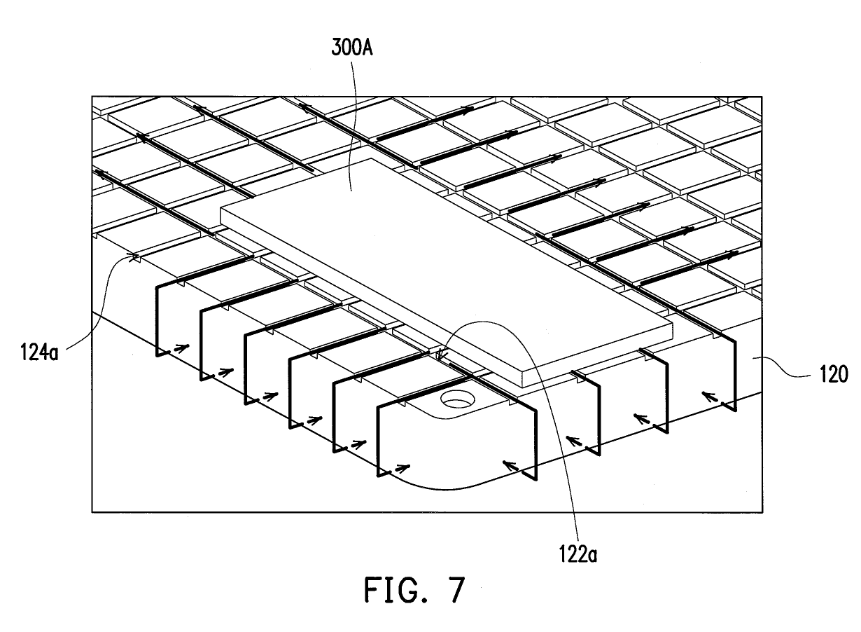

FIG. 7 is a partial schematic view of a pattern transfer mold and a workpiece according to another embodiment of the present invention. Referring to FIGS. 1A, 1B, and 7, in this embodiment, a pattern transfer mold of FIG. 7 is similar to the pattern transfer mold 100 of FIG. 1B, but differs in that, the mold core 120 in this embodiment has an upper surface 122a and a plurality of upper air grooves 124a, and a workpiece 300A is a thin flat plate disposed on the upper surface 122a of the mold core 120. The plurality of upper air grooves 124a is located on the upper surface 122a and passes through the workpiece 300A. In other words, the workpiece 300A may span across the plurality of upper air grooves 124a.

In particular, when extracting the air from the space between the film 200 and the workpiece 300A through the air vent 114, the mold air channels 128, and the upper air grooves 124a (the air flow directions are marked by arrows in FIG. 7), the film 200 is moved towards the workpiece 300A and thus uniformly attached to the workpiece 300A closely. Moreover, the film 200 is heated, so as to transfer the decorative pattern 210a on the film 200 to the workpiece 300A.

To sum up, in the present invention, through extracting the air from the space between the film and the workpiece through the air vent, the upper air grooves, and the mold air channels to apply a negative air pressure to the first surface of the film, the film is moved towards the workpiece and thus closely attached to the workpiece. Moreover, the film is heated, so as to transfer the decorative pattern on the film to the workpiece, thereby avoiding the damages on the surface of the workpiece caused by a roller upon contacting the surface of the workpiece in the prior art.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1-9. (canceled)

10. A pattern transfer method, suitable for transferring at least one decorative pattern on a film to at least one workpiece, comprising:
providing a mold base and a mold core, wherein the mold base comprises a mold cavity and an air vent associated with the mold cavity, the mold core is inserted in the mold cavity of the mold base and comprises an upper surface exposed out of the mold cavity and a plurality of upper air grooves on the upper surface, the mold cavity and the mold core comprise a plurality of mold air channels located there-between, and the upper air grooves are associated with the air vent via the mold air channels;
disposing a workpiece on the upper surface of the mold core;
positioning a film on the mold base, the mold core, and the workpiece, wherein the film comprises a first surface, a second surface opposite to the first surface, and at least one decorative pattern on the first surface, and the first surface of the film faces the workpiece;
extracting air from a space between the film and the workpiece through the air vent, the mold air channels, and the upper air grooves to apply a negative air pressure to the first surface of the film, so as to closely attach the film to the workpiece; and
heating the decorative pattern, so as to transfer the decorative pattern from the film to the workpiece.

11. The pattern transfer method according to claim 10, further comprising:
applying a positive air pressure to the second surface of the film, so as to closely attach the film to the workpiece.

12. The pattern transfer method according to claim 10, wherein the step of disposing the workpiece further comprises:
mounting the workpiece on at least one mold protrusion of the mold core protruded from the upper surface.

13. The pattern transfer method according to claim 10, wherein the step of positioning the film further comprises:
respectively fitting a plurality of positioning columns of the mold base into a plurality of positioning holes of the film.
